(19) United States
(12) Patent Application Publication
(10) Pub. No.: US 2004/0073699 A1
(43) Pub. Date: Apr. 15, 2004

(54) Dynamic routing method for multistage bus networks in distributed shared memory environment

(76) Inventors: Kang Woon Hong, Seoul (KR); Heyung Sub Lee, Daejeon (KR); Hyeong Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/387,218

(22) Filed: Mar. 11, 2003

(30) Foreign Application Priority Data
Sep. 9, 2002 (KP) 2002-54130

(51) Int. Cl. G06F 15/173; G06F 15/16

(52) U.S. Cl. 709/238; 709/253

(57) ABSTRACT

The present invention provides a dynamic routing method for a multistage bus network in a distributed shared memory environment. For performing a forward or backward U-turn routing (FUR or BUR), the forward or backward-turning allowable stage, respectively for FUR or BUR, is compared with a current stage check whether a U-turn is possible in the current stage. If not affirmative, traffic levels of switches in its next or previous stage connected to a switch in the current stage are compared to each other, respectively for FUR or BUR. A switch having the lowest traffic level is selected as a route switch of the next or previous stage, and the next or previous stage is changed to a current stage, respectively for FUR or BUR. The procedure is repeated from the checking step. If affirmative, a U-turn at the current stage is performed, and a backward or forward routing is performed, respectively for FUR or BUR.

### BACKGROUND OF THE INVENTION

1. Field of the Invention

The present invention relates to a dynamic routing method performing a dynamic control of switches in a multistage bus network, and more particularly to a dynamic routing method for a multistage bus network in a distributed shared memory environment, wherein the traffic level of each of switches in the next stage along redundant paths that are provided in a multistage bus network in the distributed shared memory environment is determined, and a packet is transferred to switches that are determined to have a low traffic level.

2. Description of the Prior Art

Generally, a parallel system is composed of a plurality of processors and memory modules, and an interconnection network for providing connections therebetween. The performance of the parallel system is affected by a number of factors. Particularly, when the system performs a process requiring frequent data communications between processors, the performance of the system depends largely on the efficiency of data transfer performed through the interconnection network. In order to achieve efficient data transfer, it is necessary to provide a route allowing a desired communication between the processors and the modules as quickly as possible.

Meanwhile, a multistage bus network is a kind of multistage interconnection network, which uses buses instead of crossbars as interconnection switches between stages. Such a multistage bus network basically has the characteristics of the multistage interconnections network, as well as a hierarchical bus structure. From a viewpoint of a transmission function, it can be said that the multistage bus network has the advantage of the multistage interconnection network in that all the stages have the same bandwidth, and simultaneously has the advantage of the hierarchical bus structure in that each stage has a group locality between the processors. Accordingly, the multistage bus network can reduce the number of switches on a route owing to the locality, while utilizing a simple routing algorithm available in the multistage interconnection network.

On the other hand, a distributed shared memory is one of memory models, which utilizes the advantages of both the distributed memory environment and the shared memory environment. That is, the distributed shared memory has such a configuration that it is physically distributed to independent memory spaces, but logically serves as one shared memory. In this memory model, a memory module is used as a local memory of a processor, and simultaneously used as part of the entire shared memory. In other words, the distributed shared memory is adapted to utilize both the characteristics of the shared memory model, which provides the program-environmental convenience and the communicational simplicity, and the characteristics of the distributed memory model, which provides system expansion capability.

Generally, the multistage interconnection network has such a configuration that it provides connections between the processors and the memory modules. FIG. 1 is a view showing the configuration of a general distributed shared memory based on a multistage bus network. As shown in this figure, a multistage bus network 101 provides connections between a number of nodes 103 and 104 that each includes a pair of a processor and a memory. There are provided a plurality of buses 105 as internal switches of the multistage bus network 101. Reference numerals 103 and 106 indicate the same nodes having the same node number which are connected to both ends of the multistage bus network 101, respectively.

In the multistage bus network 101, two buses in one of two neighboring stages satisfy a “buddy” relationship therebetween. The buddy relationship is defined as a relationship between two buses positioned in one stage, provided that each of the two buses are commonly connected to each of two buses positioned in its next or neighboring stage. FIG. 2 is an exemplary view showing the buddy relationship between switches in a general multistage bus network. Referring to FIG. 2, two buses 201 and 202 satisfy a buddy relationship therebetween, because the two buses 201 and 202 are commonly connected to each of two buses 204 and 205 positioned in the forward-next stage, while two buses 206 and 207 satisfy a buddy relationship therebetween, because the two buses 206 and 207 are commonly connected to each of two buses 204 and 205 positioned in the backward-next stage.

A general routing strategy in the multistage interconnection network uses both a binary-expressed label assigned to a requesting or source processor and a binary-expressed label assigned to a destination memory module. An Exchange calculation is performed for a data transfer in switches, whereas a Shuffle/ReverseShuffle calculation is performed for a data transfer between two consecutive stages. These calculations use a binary-expressed label of a switch port corresponding to a binary-expressed label of the processor or the destination memory module. There are two basic routing methods, one being forward routing and the other backward routing. The forward routing uses the Exchange and Shuffle calculations and the backward routing uses the Exchange and ReverseShuffle calculations.

Besides the forward and backward routings, a U-turn routing is possible in the multistage bus network. The U-turn routing is a routing method which reverses the routing direction at an intermediate stage of the network. The U-turn routing uses a route from a requesting processor to a destination memory module, and uses a fact that a route of the processor requested from the destination memory module shares the same switches in an intermediate stage. There are two kinds of U-turn routings, one being a forward U-turn routing and the other a backward U-turn routing. For example, in the case of the forward U-turn routing, when it is assumed that the U-turn is made in a stage t, a forward routing is performed from a stage 0 to the stage t, the U-turn is performed at the stage t, and then a backward routing is performed from the stage t to the stage 0.

The U-turn routing can reduce the number of switches along the route, compared with the forward or backward routings. In case of using the buddy characteristics in the U-turn routing method, even though a reference-requesting processor and a destination memory module are same number and the same routing method is selected for a data routing, the data routing can be performed along different routes, thereby distributing the traffic of the switches. These phenomena largely contribute to reducing an average response time required for the memory reference, taking into account the limitation that the multistage bus network uses a bus (i.e., a shared medium) as a switch.

In order to actually transfer a packet to a destination node, an optimum route determination procedure is needed to select one of a number of routing methods, which has a minimum number of switches along the route. FIG. 3 is a flowchart showing an optimum route-determination procedure of the prior art. Symbols used in FIG. 3 are defined as follows.

n: The number of stages of a multistage bus network

SRC: A requesting or source processor

DEST: A processor having a destination memory module

FTS: (Forward Turning Stage) A stage in which a U-turn can be performed during a forward U-turn routing

BTS: (Backward Turning Stage) A stage in which a U-turn can be performed during a backward U-turn routing

As shown in FIG. 3,

$${d}_{n} = ⌊ \frac{n}{2} ⌋ , {d}_{u} = ⌈ \frac{n}{2} ⌉$$

are set (step 301), and then it is checked whether a requesting processor SRC is coincident with a processor DEST having a destination memory module (step 302). When the checked result is affirmative, the optimum route is determined by a reference to a local memory module of the processor, without passing through the switches (step 308). When the checked result is not affirmative, a FTS and a BTS are checked (step 303). Subsequently, it is checked whether or not a U-turn is possible in a first or last stage, i.e., whether or not FTS=0 or (n−1-BTS)=0 (step 304). If the checked result is affirmative, a forward or backward U-turn routing is selected (step 309). If the checked result is not affirmative, it is checked whether the U-turn is possible at a stage before the center stage of the network (i.e., FTS<dn) (step 305). If the checked result is affirmative (FTS<dn), the forward U-turn routing is selected (step 310). If the checked result is not affirmative (FTS≧dn), it is checked whether the U-turn is possible at a stage equal to or after the center stage of the network (i.e., BTS≧du) (step 306). If the checked result is affirmative (BTS≧du), the backward U-turn routing is selected (step 311). If the checked result is not affirmative (BTS<du), a forward or backward routing is selected, where the number of switches along the route is equal or larger than that of the case where the forward or backward U-turn routing is selected (step 307).

However, the prior art routing method such as forward and backward routings and forward and backward U-turn routings all belong to a static routing strategy where the route is determined in advance before the data transfer. The static routing strategy is conceptually opposite to a dynamic routing strategy in terms of a point of time to determine the route. It is to be noted that, in the case of the U-turn routing, the multistage bus network having the buddy relationship between the switches always has at least two routes between two consecutive stages. However, the prior art routing method cannot change the route depending on the condition of the network, failing to utilize switches that are not frequently used or not in use. In addition, the prior art routing method cannot distribute the traffic of the switches, and thus the time required to process a packet is increased, thereby causing an increase of the average response time of the entire system. Further, in the prior art static routing strategy, the forward/backward routing is selected in the case where the number of switches along the route in the forward/backward routing is equal to the number of switches along the route in the forward/backward U-turn routing. That is, the static routing method has such a problem that it is performed solely based on the number of switches, without considering the traffic of the switches.

### SUMMARY OF THE INVENTION

The present invention provides a dynamic routing method for a multistage bus network of distributed shared memory environment, wherein the characteristics of the multistage bus network of distributed shared memory environment is taken into consideration such that the traffic level of each of switches in the next stage along redundant paths that are provided in a multistage bus network in a distributed shared memory environment is determined, and a packet transfer route is dynamically set to pass through switches that are determined to have a low traffic level, thereby reducing the packet processing time and the average response time of the system.

In accordance with the present invention, the above and other objects can be accomplished by the provision of a dynamic routing method for a multistage bus network in a distributed shared memory environment, wherein, when a forward U-turn routing is performed, the method comprises: a first step of calculating a stage where a forward U-turn is possible; a second step of comparing the calculated stage with a current stage so as to check whether a U-turn is possible in the current stage; a third step of, when the checked result of the second step is not affirmative, checking traffic levels of a plurality of switches in a next stage which are connected to a switch in the current stage; a fourth step of selecting a switch having the lowest traffic level of the checked switches as a route switch of the next stage, changing the next stage to a current stage, and then repeating a procedure from the second step; and

a fifth step of, when the checked result of the second step is affirmative, performing a U-turn at the current stage, and performing a backward routing; and when a backward U-turn routing is performed, the method comprises: a sixth step of calculating a stage where a backward U-turn is possible; a seventh step of comparing the calculated stage with a current stage so as to check whether a U-turn is possible in the current stage; an eighth step of, when the checked result of the seventh step is not affirmative, checking traffic levels of a plurality of switches in a previous stage which are connected to a switch in the current stage; a ninth step of selecting a switch having the lowest traffic level of the checked switches as a route switch of the previous stage, changing the previous stage to a current stage, and then repeating a procedure from the seventh step; and a tenth step of, when the checked result of the seventh step is affirmative, performing a U-turn at the current stage, and performing a forward routing.

The multistage bus network having the buddy relationship always has at least two routes between two consecutive stages when the U-turn routing is performed. Taking into consideration such characteristics of the multistage bus network, the present invention utilizes redundant routes in the multistage bus network in the distributed shared memory environment, and dynamically determines the switch route, according to the traffic condition of switches. Accordingly, when a specific switch or link along the route is in an abnormal traffic condition, the routing is performed so as to avoid the specific switch or link. Such a dynamic or adaptive routing method allows avoidance of network congestion and securing of a sufficient bandwidth in communication, thereby improving the packet processing speed. That is, the dynamic routing method of the present invention has been made in consideration of the switch traffic in the conventional forward/backward U-turn routing method. Consequently, both the average response time of the system and the average number of queue packets on the switch can be reduced, while achieving a system expansion capability. In addition, a U-turn is allowed even at the center stage in a multistage bus network having an odd number of stages, and a routing can be made to a switch of a stage before the center stage, which has switch traffic lower than a stage after the center stage, in result, obtaining the advantages as mentioned above.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of a distributed shared memory based on a general multistage bus network;

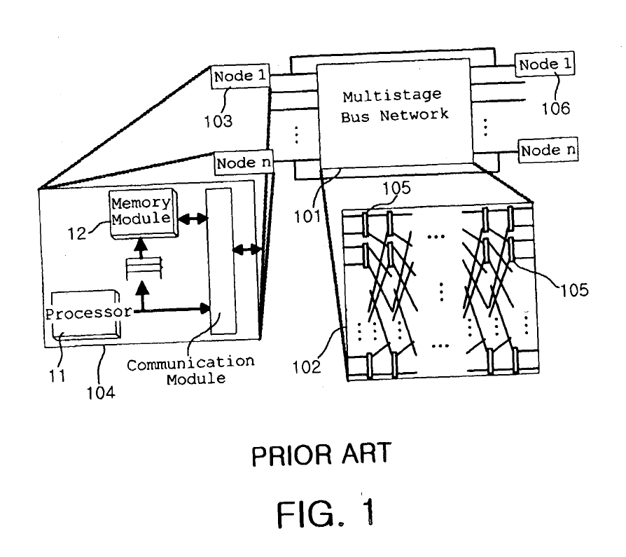

FIG. 2 is an exemplary view of a buddy relationship between switches in a general multistage bus network;

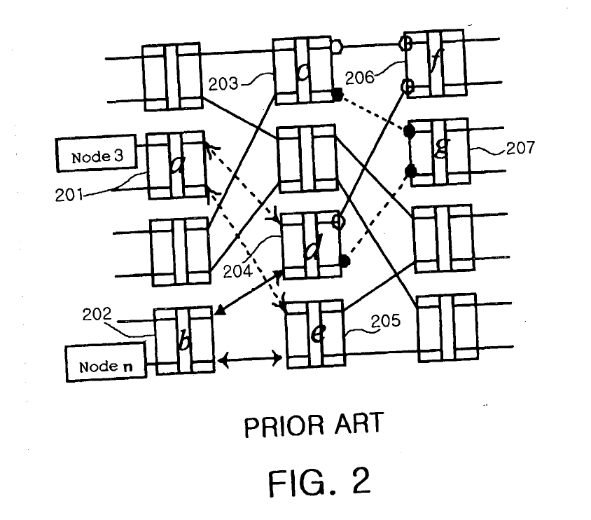

FIG. 3 is a flowchart illustrating an optimum-route determination method of the prior art;

FIGS. 4a and 4b are flowcharts illustrating dynamic forward and backward U-turn routing procedures according to the present invention, respectively; and

FIG. 5 is a flowchart illustrating a dynamic optimum-route determination method according to the present invention.

### DESCRIPTION OF THE PREFERRED EMBODIMENTS

Now, a preferred embodiment of the present invention will be described in detail referring to the drawings. In the following description of the present invention, a switch in a multistage bus network means a bus, i.e., the bus and the switch are used alternatively.

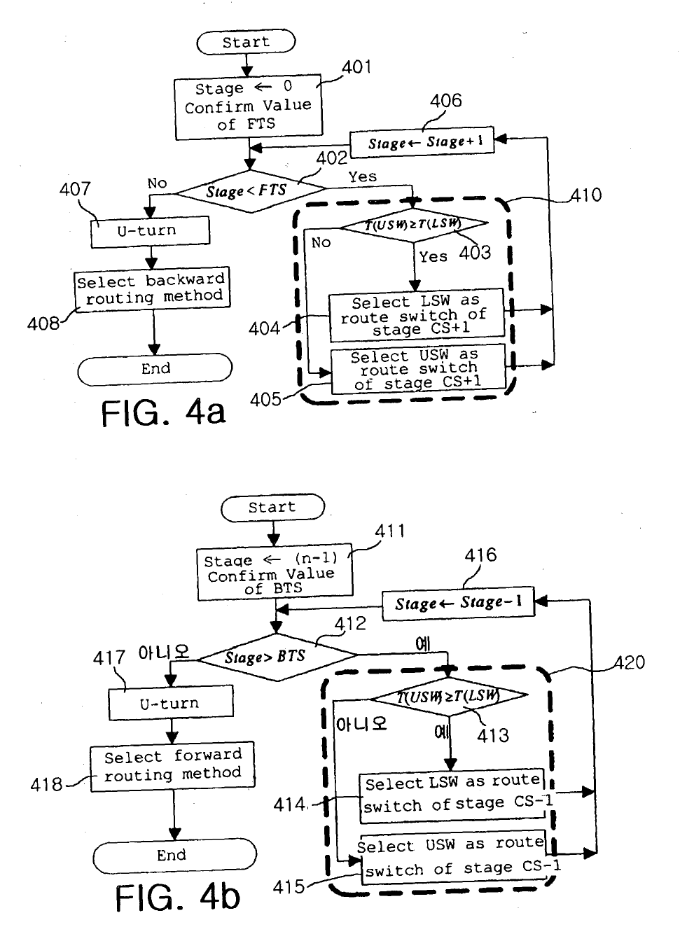

FIGS. 4a and 4b are flowcharts illustrating the procedure of a dynamic U-turn routing, according to the present invention. In detail, FIG. 4a is a flowchart illustrating the procedure of a dynamic forward U-turn routing, and FIG. 4b is a flowchart illustrating the procedure of a dynamic backward U-turn routing. Symbols used in the procedure of the dynamic forward U-turn routing as shown in FIG. 4a are as follows.

n: The number of stages of a multistage bus network

SRC: A requesting or source processor

DEST: A processor having a destination memory module

FTS: (Forward Turning Stage) A stage in which U-turn can be performed during a forward U-turn routing (0≦FTS≦n−1)

T(SW): A value indicating the traffic level of the corresponding switch, where the value of SW is USW or LSW

Sᵢ: i^{th} bit, (0≦i≦n−1

S₀S₁S₂ . . . Sₙ₋₁: The binary-expressed label of a processor and a switch port

CS: The current stage on the route, (0≦CS≦n−1

USW: One, connected in the case where Si=0, of two switches in a stage (i+1) which are connected to a switch in a stage i

LSW: One, connected in the case where Si=1, of two switches in the stage (i+1) which are connected to the switch in a stage i

The procedure of the dynamic forward U-turn routing according to the present invention, as shown in FIG. 4a, basically aims to select a route switch, of switches connected to a switch positioned in a stage, based on their traffic levels. Now, the procedure of the dynamic forward U-turn routing is described referring to FIG. 4a. First, the stage value of the current stage CS in the multistage bus network is set to 0, and the value of a forward turning stage (FTS) where a forward U-turn routing is possible is confirmed (step 401). Subsequently, the set stage value of the current stage CS is compared with the value of the FTS (step 402). If the comparison result is that the value of the FTS is larger than the set stage value of the current stage CS, a value T(USW) is compared with a value T(LSW) (step 403). Here, the value T(USW) indicates the traffic level of a switch USW, connected in the case where the bit Si is 0, of two switches in the next stage CS+1 connected to a corresponding switch in the current stage CS, and the value T(LSW) indicates the traffic level of a switch LSW, connected in the case where the bit Si is 1, of the two switches in the next stage CS+1 connected to the switch in the current stage CS. That is, the step 403 is to compare the traffic levels between the two switches in the next stage CS+1 connected to the switch in the present switch CS. In the case where the comparison result is that T(USW) is larger than T(LSW), indicating that the traffic level of the switch USW is higher than that of the switch LSW in the next stage CS+1, the switch LSW having the lower traffic level is selected as the next switch in the next stage CS+1 (step 404). Subsequently, the procedure moves to step 406 to advance to the next stage CS+1 by adding one stage to the current stage CS, and the procedure is repeated from the step 402 in the next stage CS+1. On the contrary, in the case where the comparison result of step 403 is that T(USW) is lower than T(LSW), indicating that the traffic level of the switch USW is lower than that of the switch LSW in the next stage CS+1, the switch USW having the lower traffic level is selected as the next switch in the next stage CS+1 (step 405). Subsequently, the procedure moves to step 406 to advance to the next stage CS+1 by adding one stage to the current stage CS, and the procedure is repeated from the step 402 in the next stage CS+1.

On the other hand, if the comparison result of step 402 is that the stage value of the current stage is larger than the value of FTS, indicating the U-turn is possible in the current stage, the U-turn is performed (step 407), and a backward routing procedure is performed (step 408).

The route selection procedure of FIG. 4a is the same as the forward routing method, until reaching the stage where the U-turn is possible, but includes step 410 where the values T(SW) indicating the traffic levels of the switches in the next stage CS+1 connected to the current stage CS on the route are compared to each other (step 403) to select the switch having the lower traffic level in the next stage CS+1. This step 410 is indicated by a dotted line in FIG. 4a. As a result of the step 410, the binary-expressed label of the switch port in the current stage CS is converted in the next stage CS+1. Such a conversion procedure is as follows. That is, in the case where LSW is selected as the switch in the next stage CS+1 (step 404), when the value of Sₙ₋₁ for the switch port in the current stage CS is 0, the binary-expressed label is converted from S₀S₁ . . . Sₙ₋₂Sₙ₋₁ to S₁S₂ . . . \overline{Sₙ₋₁}S₀, whereas when the value of Sₙ₋₁ is 1, the label is converted from S₀S₁ . . . . Sₙ₋₂Sₙ₋₁ to S₁S₂ . . . Sₙ₋₁S₀. Similarly, in the case where USW is selected as the switch in the next stage CS+1 (step 405), when the value of Sₙ₋₁ for the switch port in the current stage CS is 0, the label is converted from S₀S₁ . . . Sₙ₋₂Sₙ₋₁ to S₁S₂ . . . Sₙ₋₁S₀, whereas when the value of Sₙ₋₁ is 1, the label is converted from S₀S₁ . . . Sₙ₋₂Sₙ₋₁ to S₁S₂ . . . \overline{Sₙ₋₁}S₀. In such a manner, the step 410 is repeated, incrementing the stage value of the current stage by one, and when the stage FTS where the U-turn is possible is reached, the U-turn is performed (step 407), and the backward routing procedure is performed (step 408).

Now, the procedure of the dynamic backward U-turn routing is described referring to FIG. 4b. Symbols used in the procedure of the dynamic backward U-turn routing as shown in FIG. 4b are as follows.

n: The number of stages of a multistage bus network

SRC: A requesting or source processor

DEST: A processor having a destination memory module

BTS: (Backward Turning Stage) A stage in which a U-turn can be performed during a backward U-turn routing (0≦BTS≦n−1)

T(SW): A value indicating the traffic level of the corresponding switch, where the value of SW is USW or LSW

Sᵢ: i^{th} bit, (0≦i≦n−1)

S₀S₁S₂ . . . Sₙ₋₁: The binary-expressed label of a processor and a switch port

CS: The current stage on the route, (0≦CS≦n−1)

USW: One, connected in the case where Si=0, of two switches in a stage (i-1) which are connected to a switch in a stage i

LSW: One, connected in the case where Si=1, of two switches in the stage (i-1) which are connected to the switch in a stage i

The procedure of the dynamic backward U-turn routing according to the present invention, as shown in FIG. 4b, also basically aims to select a route switch, of switches connected to a switch positioned in a stage, based on their traffic levels. Now, the procedure of the dynamic backward U-turn routing is described referring to FIG. 4b. First, the stage value of the current stage CS in the multistage bus network is set to n−1 and the value of a backward turning stage (BTS) where a backward U-turn routing is possible is confirmed (step 411). Subsequently, the set stage value of the current stage CS is compared with the stage value of the BTS (step 412). If the comparison result is that the value of the BTS is lower than the set value of the current stage CS, a value T(USW) is compared with a value T(LSW) (step 413). Here, the value T(USW) indicates the traffic level of a switch USW, connected in the case where the bit Si is 0, of two switches in the previous stage CS-1 connected to a corresponding switch in the current stage CS, and the value T(LSW) indicates the traffic level of a switch LSW, connected in the case where the bit Si is 1, of the two switches in the previous stage CS-1 connected to the switch in the current stage CS. That is, the step 413 is to compare the traffic levels between the two switches in the previous stage CS-1 connected to the switch in the present switch CS. In the case where the comparison result is that T(USW) is higher than T(LSW), indicating that the traffic level of the switch USW is higher than that of the switch LSW in the previous stage CS-1, the switch LSW having the lower traffic level is selected as the previous switch in the previous stage CS-1 (step 414). Subsequently, the procedure moves to step 416 to advance to the previous stage CS-1 by subtracting one stage from the current stage CS, and the procedure is repeated from the step 412 in the previous stage CS-1. On the contrary, in the case where the comparison result of step 413 is that T(USW) is lower than T(LSW), indicating that the traffic level of the switch USW is lower than that of the switch LSW in the previous stage CS-1, the switch USW having the lower traffic level is selected as the previous switch in the previous stage CS-1 (step 415). Subsequently, the procedure moves to step 416 to advance to the previous stage CS-1 by subtracting one stage from the current stage CS, and the procedure is repeated from the step 412 in the previous stage CS-1.

On the other hand, if the comparison result of step 412 is that the stage value of the current stage is lower than the value of BTS, indicating the U-turn is possible in the current stage, the U-turn is performed (step 417), and a forward routing procedure is performed (step 418).

The route selection procedure of FIG. 4b is the same as the backward routing method, until reaching the stage where the U-turn is possible, but includes step 420 where the values T(SW) indicating the traffic levels of the switches in the previous stage CS-1 connected to the current stage CS on the route are compared to each other (step 413) to select the switch having the lower traffic level in the previous stage CS-1. This step 420 is indicated by a dotted line in FIG. 4b. As a result of the step 420, the binary-expressed label of the switch port in the current stage CS is converted in the previous stage CS-1. Such a conversion procedure is as follows. That is, in the case where LSW is selected as the switch in the previous stage CS-1 (step 414), when the value of Sₙ₋₁ for the switch port in the current stage CS is 0, the binary-expressed label is converted from S₀S₁ . . . Sₙ₋₂Sₙ₋₁ to \overline{Sₙ₋₁}S₀S₁ . . . Sₙ₋₂, whereas when the value of Sₙ₋₁ is 1, the label is converted from S₀S₁ . . . Sₙ₋₂Sₙ₋₁ to Sₙ₋₁S₀S₁ . . . Sₙ₋₂. Similarly, in the case where USW is selected as the switch in the previous stage CS-1 (step 415), when the value of Sₙ₋₁ for the switch port in the current stage CS is 0, the label is converted from S₀S₁ . . . Sₙ₋₂Sₙ₋₁ to Sₙ₋₁S₀S₁ . . . Sₙ₋₂, whereas when the value of Sₙ₋₁ is 1, the label is converted from S₀S₁ . . . Sₙ₋₂Sₙ₋₁ to \overline{Sₙ₋₁}S₀S₁ . . . Sₙ₋₂. In such a manner, the step 420 is repeated, decrementing the stage value of the current stage by one, and when the stage BTS where the U-turn is possible is reached, the U-turn is performed (step 417), and the forward routing procedure is performed (step 418).

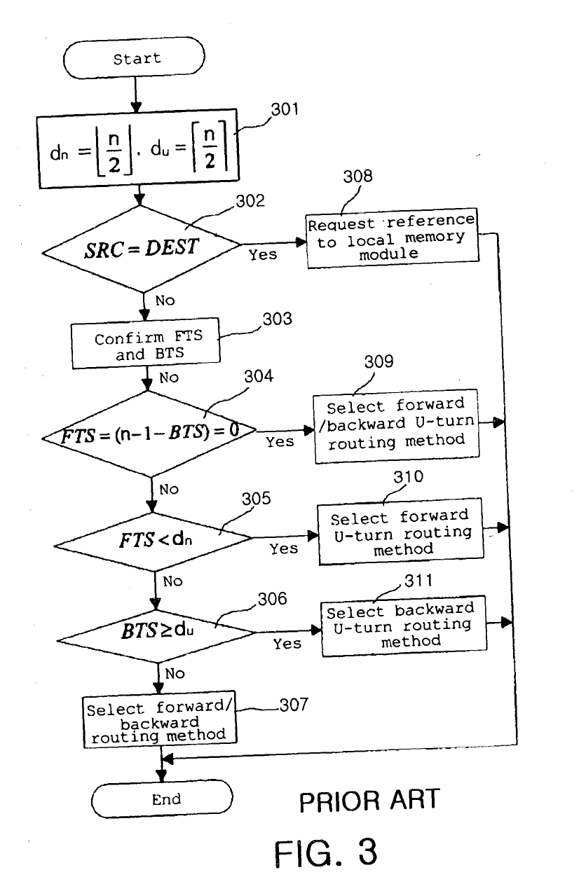

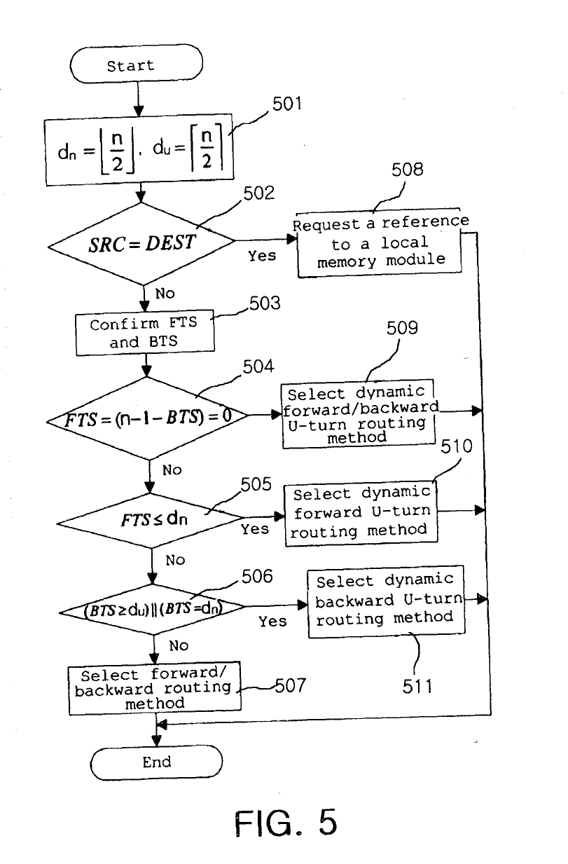

FIG. 5 is a flowchart illustrating the dynamic optimum-route determination method according to the present invention. The method of FIG. 5 is definitely different from the conventional optimum-route determination method of FIG. 3, in that there is a high possibility that the proposed dynamic routing method is selected. That is, according to the present invention, a routing method minimizing the number of switches along the route is selected, so as to obtain an improved optimum-route determination method, thereby minimizing the number of switches along the route, while increasing the utilization of the dynamic routing method. Now, the dynamic optimum-route determination method according to the present invention is described in detail referring to FIG. 5. As shown in FIG. 5,

$${d}_{n} = ⌊ \frac{n}{2} ⌋ , {d}_{u} = ⌈ \frac{n}{2} ⌉$$

are set (step 501), and then it is checked whether a requesting processor SRC is coincident with a processor DEST having a destination memory module (step 502). When the checked result is affirmative, the optimum route is determined by a reference to a local memory module of the processor, without passing through the switches (step 508). When the checked result is not affirmative, a FTS and a BTS are checked (step 503). Subsequently, it is checked whether or not a U-turn is possible in a first or last stage, i.e., whether or not FTS=0 or (n−1-BTS)=0 (step 504). If the checked result is affirmative, a dynamic forward or backward U-turn routing is selected (step 509). If the checked result is not affirmative, it is checked whether the U-turn is possible at a stage equal to or before the center stage of the network (i.e., FTS≦dn) (step 505). If the checked result is affirmative (FTS≦dn), the dynamic forward U-turn routing is selected (step 510). If the checked result is not affirmative (FTS>dn), it is checked whether the U-turn is possible at a stage equal to or after the center stage of the network, i.e., it is checked whether or not BTS≧du or BTS=dn (step 506). If the checked result is affirmative (BTS≧du or BTS=dn), the dynamic backward U-turn routing is selected (step 511). If the checked result is not affirmative, a forward or backward routing is selected if the number of switches along the route when the backward U-turn routing is selected is equal or larger than that of the case where the forward or backward routing is selected (step 507).

The present invention uses the condition (i.e., BTS≧du or BTS=dn) in the step 502 so as to increase the utilization of the dynamic routing method in the case where the number of switches along the route of the dynamic routing method according to the present invention is equal to that of the conventional routing method of FIG. 3. In other words, a forward or backward routing is performed at the center stage in the convention routing method. On the contrary, according to the present invention, a U-turn is possible even at the center stage, allowing a dynamic routing to a switch having a lower traffic level. If the U-turn is not performed at a time when reaching the stage FTS or BTS under the condition that the number of switches along the route of the dynamic routing method is equal to that of the conventional routing method of FIG. 3, the forward or backward routing may also be performed from the stage FTS or BTS. This situation should satisfy a condition that a route by the dynamic routing is coincident with a route by the forward or backward routing until reaching the stage FTS or BTS. However, the possibility of satisfying the condition is ½^{t} when the U-turn is performed at a stage t. This means that as the turning stage t is increased, the possibility is decreased according to exponential distribution. Therefore, according to the present invention, the dynamic routing method is always selected in the case where the dynamic routing method and the forward or backward routing method have the same number of switches along the route.

As apparent from the above description, the present invention has advantages in that the packet can be dynamically routed while traveling along the route, thereby allowing the utilization of redundant paths that cannot be used in the static routing method of the prior art. In addition, the traffic of the switches is distributed to reduce the average number of queue packets, allowing reducing the time required for passing through the switches, in result, decreasing the average response time of the entire system.

Further, it is possible to reduce the time necessary for obtaining the results of applications for the parallel processing system, and it is also possible to use a switch having a smaller/limited queue size when the system is manufactured as a hardware, thereby reducing the manufacturing cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dynamic routing method for a multistage bus network in a distributed shared memory environment, wherein, when a forward U-turn routing is performed, the method comprises:
a first step of calculating a stage where a forward U-turn is possible;
a second step of comparing the calculated stage with a current stage so as to check whether a U-turn is possible in the current stage;
a third step of, when the checked result of the second step is not affirmative, checking traffic levels of a plurality of switches in a next stage which are connected to a switch in the current stage;
a fourth step of selecting a switch having the lowest traffic level of the checked switches as a route switch of the next stage, changing the next stage to a current stage, and then repeating a procedure from the second step; and
a fifth step of, when the checked result of the second step is affirmative, performing a U-turn at the current stage, and performing a backward routing; and
when a backward U-turn routing is performed, the method comprises:
a sixth step of calculating a stage where a backward U-turn is possible;
a seventh step of comparing the calculated stage with a current stage so as to check whether a U-turn is possible in the current stage;
an eighth step of, when the checked result of the seventh step is not affirmative, checking traffic levels of a plurality of switches in a previous stage which are connected to a switch in the current stage;
a ninth step of selecting a switch having the lowest traffic level of the checked switches as a route switch of the previous stage, changing the previous stage to a current stage, and then repeating a procedure from the seventh step; and
a tenth step of, when the checked result of the seventh step is affirmative, performing a U-turn at the current stage, and performing a forward routing.

2. The dynamic routing method according to claim 1, wherein the stage calculated at the first step is a stage equal to or before a center stage.

3. The dynamic routing method according to claim 1, wherein the stage calculated at the sixth stage is a stage equal to or after a center stage.

4. The dynamic routing method according to claim 1, wherein, when the forward U-turn routing is performed, the fourth step further comprises:
a step of converting a label of a switch port of the switch in the current stage into a label of a switch port of the switch having the lowest traffic level in the next stage.

5. The dynamic routing method according to claim 4, wherein the label conversion step includes one of the steps:
a) when a value of Sₙ₋₁ for the switch port in the current stage is 0, converting the label of the switch port from S₀S₁ . . . Sₙ₋₂Sₙ₋₁ to S₁S₂ . . . \overline{Sₙ₋₁}S₀, whereas when the value of Sₙ₋₁ is 1, converting the label from S₀S₁ . . . Sₙ₋₂Sₙ₋₁ to S₁S₂ . . . Sₙ₋₁S₀, or
b) when the value of Sₙ₋₁ for the switch port in the current stage is 0, converting the label of the switch port from S₀S₁ . . . Sₙ₋₂Sₙ₋₁ to S₁S₂ . . . Sₙ₋₁S₀, whereas when the value of Sₙ₋₁ is 1, converting the label from S₀S₁ . . . Sₙ₋₂Sₙ₋₁ to S₁S₂ . . . \overline{Sₙ₋₁}S₀, wherein the n indicates the number of stages in the multistage bus network, and the Sᵢ indicates i^{th} bit (0≦i≦n−1.

6. The dynamic routing method according to claim 1, wherein, when the backward U-turn routing is performed, the ninth step further comprises:
a step of converting a label of a switch port of the switch in the current stage into a label of a switch port of the switch having the lowest traffic level in the previous stage.

7. The dynamic routing method according to claim 6, wherein the label conversion step includes one of the steps:
c) when a value of Sₙ₋₁ for the switch port in the current stage is 0, converting the label of the switch port from S₀S₁ . . . Sₙ₋₂Sₙ₋₁ to \overline{Sₙ₋₁}S₀S₁ . . . Sₙ₋₂, whereas when the value of Sₙ₋₁ is 1, converting the label from S₀S₁ . . . Sₙ₋₂Sₙ₋₁ to Sₙ₋₁S₀S₁ . . . Sₙ₋₂; or
d) when the value of Sₙ₋₁ for the switch port in the current stage is 0, converting the label of the switch port from S₀S₁ . . . Sₙ₋₂Sₙ₋₁ to Sₙ₋₁S₀S₁ . . . Sₙ₋₂, whereas when the value of Sₙ₋₁ is 1, converting the label from S₀S₁ . . . Sₙ₋₂Sₙ₋₁ to \overline{Sₙ₋₁}S₀S₁ . . . Sₙ₋₂, wherein the n indicates the number of stages in the multistage bus network, and the Sᵢ indicates i^{th} bit (0≦i≦n−1).
